(19) United States
(12) Patent Application Publication
(10) Pub. No.: US 2025/0174942 A1
(43) Pub. Date: May 29, 2025

(54) Connector Core Assembly, Connector and Connector Assembly

(71) Applicant: Tyco Electronics (Shanghai) Co., Ltd., Shanghai (CN)

(72) Inventors: Aibing (Alan) Dong, Shanghai (CN); Liqiang (Gino) Yao, Shanghai (CN); Yong (Chris) Wang, Shanghai (CN); Yingchun (David) Wang, Shanghai (CN)

(73) Assignee: Tyco Electronics (Shanghai) Co., Ltd., Shanghai (CN)

(21) Appl. No.: 18/962,448

(22) Filed: Nov. 27, 2024

(30) Foreign Application Priority Data
Nov. 27, 2023 (CN) 202311598270.2

(51) Int. Cl. H01R 13/6581; H01R 13/424; H01R 13/6592

(52) U.S. Cl. CPC H01R 13/6581; H01R 13/424; H01R 13/6592

(57) ABSTRACT

A connector core assembly includes a core body having a power terminal hole, a signal terminal hole, a grounding terminal hole, and a data module hole, a power terminal disposed in the power terminal hole, a signal terminal disposed in the signal terminal hole, a grounding terminal disposed in the grounding terminal hole, and a data module disposed in the data module hole. The data module includes a shielding shell, an insulator installed in the shielding shell, and a plurality of data terminals disposed in the insulator. The shielding shell isolates the data terminals from the power terminal, the signal terminal, and the ground terminal.

### CROSS-REFERENCE TO RELATED APPLICATION

This application claims the benefit of the filing date under 35 U.S.C. § 119 (a)-(d) of Chinese Patent Application No. 202311598270.2, filed on Nov. 27, 2023.

### FIELD OF THE INVENTION

The present invention relates to a connector core assembly, a connector comprising the connector core assembly, and a connector assembly comprising the connector.

### BACKGROUND OF THE INVENTION

With the rapid development of industrial equipment such as industrial robots and industrial servo motors, miniaturization and integration have become inevitable trends in technological development. As an essential part of electrical equipment input and output, the miniaturization and integration of electrical connectors are inevitable trends in providing power, signal, and data transmission simultaneously in a small space. In the prior art, electrical connectors usually only integrate power terminals and signal terminals, without terminals for transmitting data (such as terminals for transmitting Cat5 data). Therefore, in the prior art, it is necessary to provide a separate data connector, which can lead to increased costs, increased volume, inconvenience in use.

### SUMMARY OF THE INVENTION

A connector core assembly includes a core body having a power terminal hole, a signal terminal hole, a grounding terminal hole, and a data module hole, a power terminal disposed in the power terminal hole, a signal terminal disposed in the signal terminal hole, a grounding terminal disposed in the grounding terminal hole, and a data module disposed in the data module hole. The data module includes a shielding shell, an insulator installed in the shielding shell, and a plurality of data terminals disposed in the insulator. The shielding shell isolates the data terminals from the power terminal, the signal terminal, and the ground terminal.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector core assembly according to an exemplary embodiment of the present invention when viewed from the front;

FIG. 2 shows an illustrative perspective view of a connector core assembly according to an exemplary embodiment of the present invention when viewed from one side;

FIG. 3 shows an illustrative exploded view of a connector core assembly according to an exemplary embodiment of the present invention when viewed from the rear;

FIG. 4 shows an illustrative exploded view of a connector core assembly according to an exemplary embodiment of the present invention when viewed from the front;

FIG. 5 shows an illustrative perspective view of a connector core assembly according to an exemplary embodiment of the present invention when viewed from one side, wherein a C-shaped holder and a threaded connection piece for fixing the grounding terminal are shown;

FIG. 6 shows an illustrative perspective view of the core body of a connector core assembly according to an exemplary embodiment of the present invention when viewed from one side;

FIG. 7 shows an illustrative perspective view of the core body of a connector core assembly according to an exemplary embodiment of the present invention when viewed from the rear;

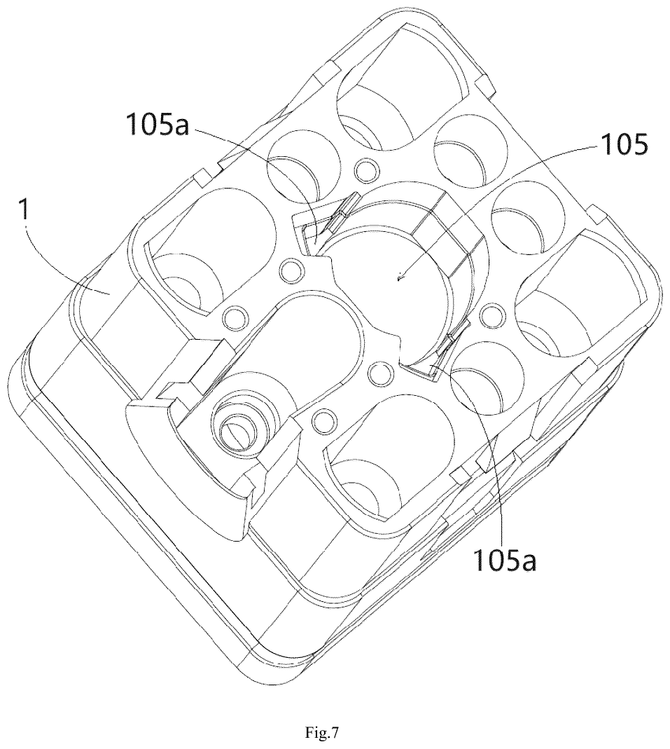

FIG. 8 shows an illustrative perspective view of a connector core assembly according to an exemplary embodiment of the present invention, with the core body removed;

FIG. 9 shows an illustrative assembly view of the end cover and data module of a connector core assembly according to an exemplary embodiment of the present invention;

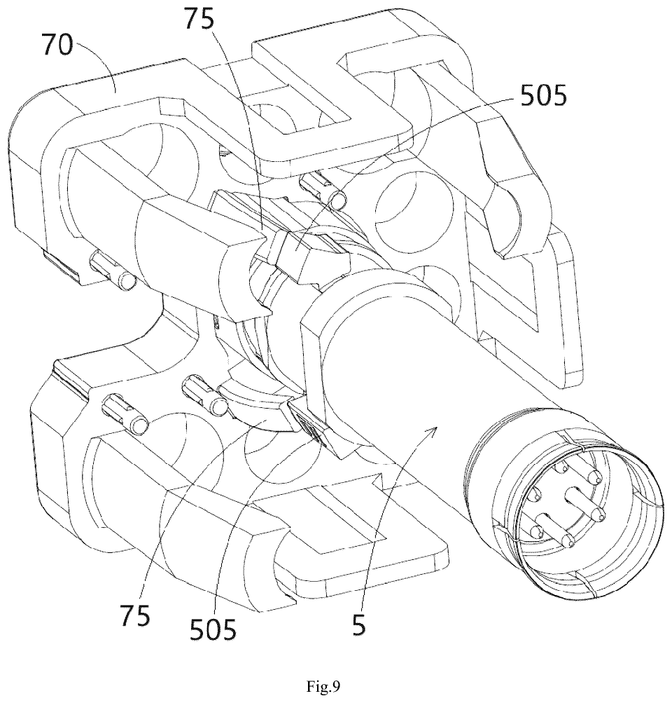

FIG. 10 shows an illustrative exploded view of the end cover and data module of a connector core assembly according to an exemplary embodiment of the present invention;

FIG. 11 shows an illustrative perspective view of a signal terminal of a connector core assembly according to an exemplary embodiment of the present invention;

FIG. 12 shows an illustrative perspective view of the grounding terminal of a connector core assembly according to an exemplary embodiment of the present invention;

FIG. 13 shows an illustrative perspective view of a data module of a connector core assembly according to an exemplary embodiment of the present invention;

FIG. 14 shows an axial sectional view of a data module of a connector core assembly according to an exemplary embodiment of the present invention;

FIG. 15 shows an illustrative exploded view of the data module of a connector core assembly according to an exemplary embodiment of the present invention;

FIG. 16 shows an illustrative perspective view of the insulator, insulation sleeve, and data terminal of the data module of the connector core assembly according to an exemplary embodiment of the present invention when viewed from the front; and

FIG. 17 shows an illustrative perspective view of the insulator, insulation sleeve, and data terminal of the data module of the connector core assembly according to an exemplary embodiment of the present invention when viewed from the rear.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

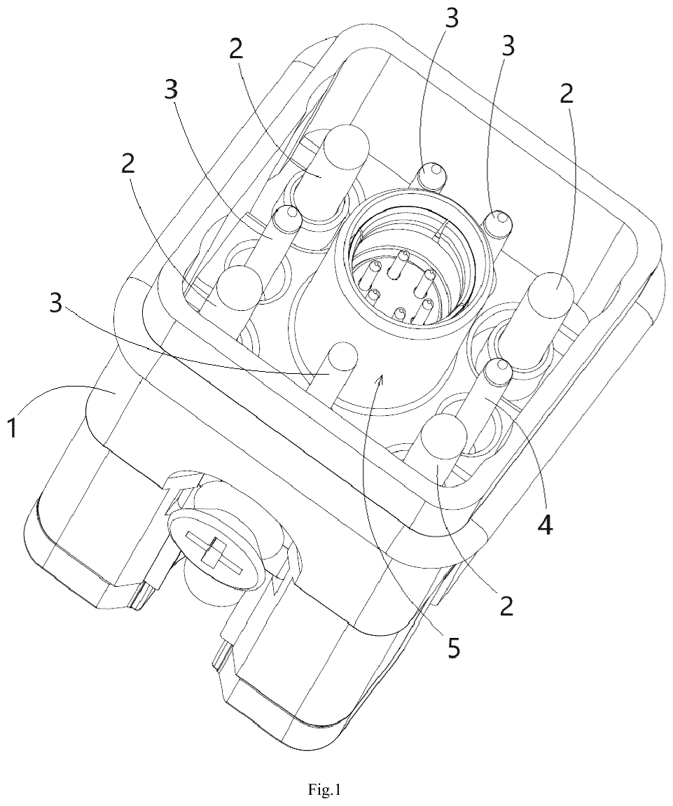

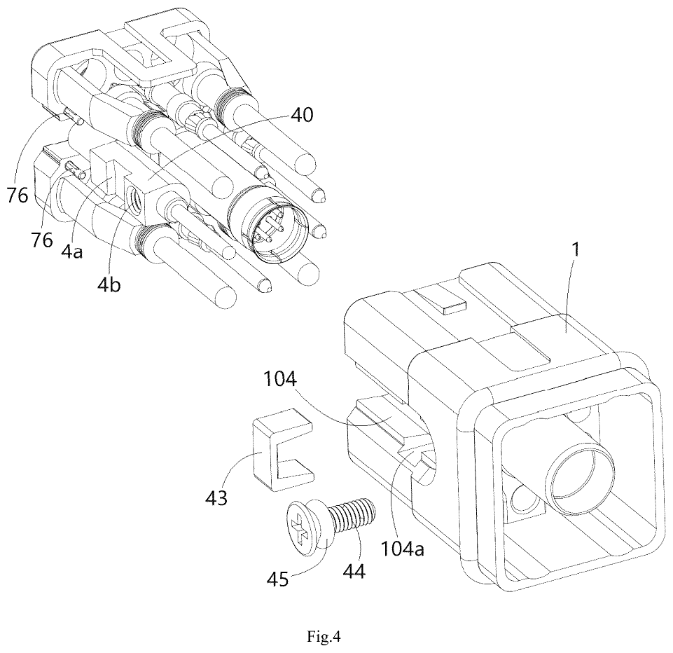

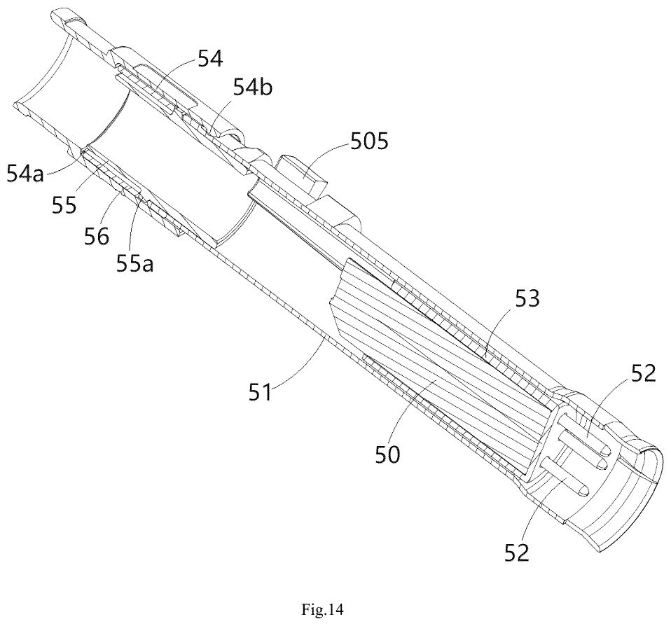

As shown in FIGS. 1-4 and 13-17, in an exemplary embodiment of the present invention, a connector core assembly is disclosed. The connector core assembly includes a core body 1, a power terminal 2, a signal terminal 3, a grounding terminal 4, and a data module 5. A power terminal hole 102, a signal terminal hole 103, a ground terminal hole 104, and a data module hole 105 are formed in the core body 1. The power terminal 2 is provided in the power terminal hole 102. The signal terminal 3 is provided in signal terminal hole 103. The grounding terminal 4 is provided in the grounding terminal hole 104. The data module 5 is provided in the data module hole 105.

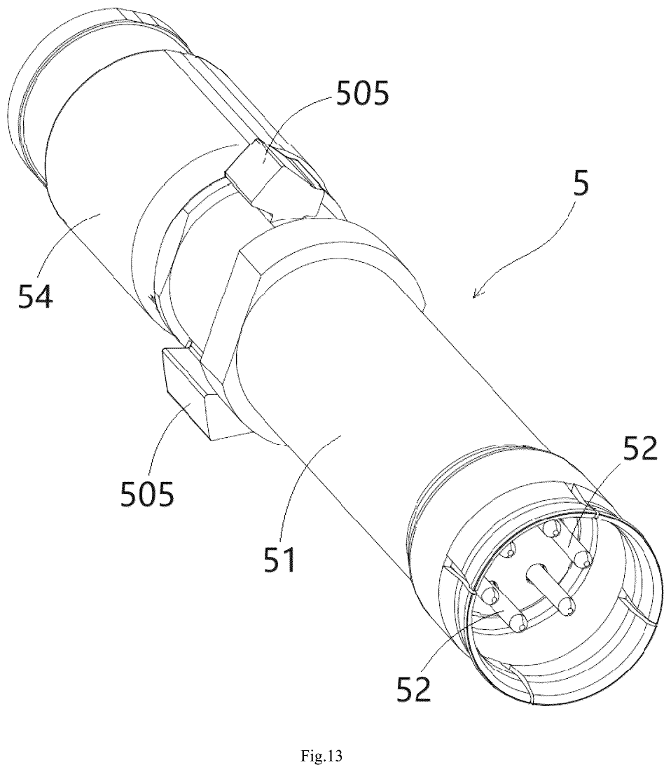

As shown in FIGS. 13-17, in the illustrated embodiment, the data module 5 includes a shielding shell 51, an insulator 50, and a plurality of data terminals 52. The insulator 50 is provided in the shielding shell 51. The data terminals 52 are arranged in the insulator 50. The shielding shell 51 isolates the data terminals 52 from the power terminal 2, signal terminal 3, and ground terminal 4. In the shown embodiment, the data terminals 52 are used to transmit Ethernet data, such as Cat5 data.

As shown in FIGS. 13-17, in the illustrated embodiment, the insulator 50 includes a cylindrical main body 500, and a plurality of outward opening receiving slots 501 are formed on the outer peripheral surface of the main body 500. The receiving slots 501 extend along the axial direction of the main body 500 and are distributed at intervals in the circumferential direction of the main body 500. The data terminals 52 are respectively arranged in the multiple receiving slots 501.

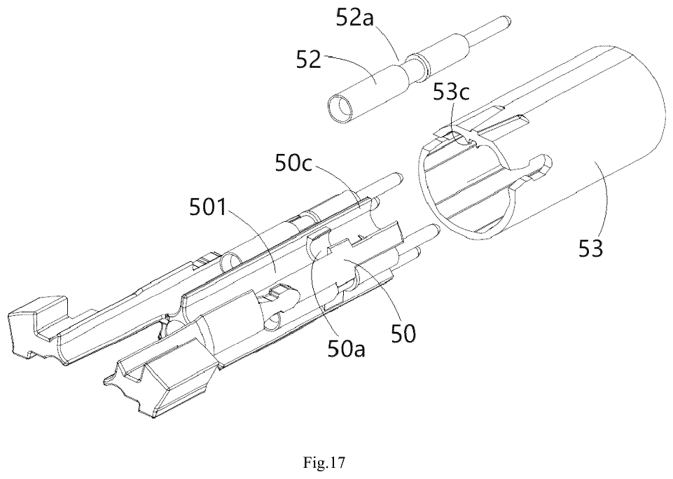

As shown in FIG. 17, in the illustrated embodiment, a C-shaped snap ring portion 50c is formed in the receiving slot 501, and a snap slot 52a is formed on the data terminal 52. The C-shaped snap ring portion 50c is snapped into the snap slot 52a on the data terminal 52 to hold the data terminal 52 in the receiving slot 501.

As shown in FIGS. 13-17, in the illustrated embodiment, the data module 5 further includes an insulation sleeve 53, which is fitted onto the main body 500 of the insulator 50. The peripheral wall 530 of the insulation sleeve 53 is used to rest against the data terminal 52, to constrain the data terminal 52 in the receiving slot 501 of the insulator 50.

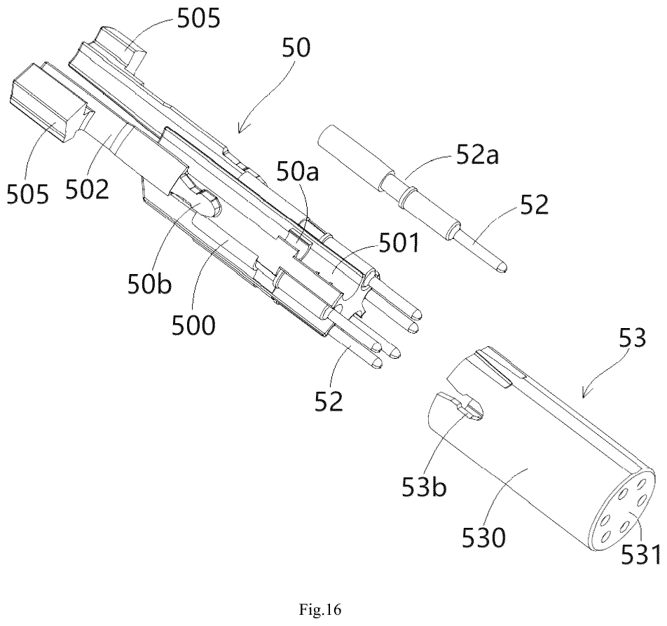

As shown in FIG. 16, in the illustrated embodiment, an engagement protrusion 50b is formed on the outer surface of the rear end of the main body 500 of the insulator 50, and an engagement recess 53b is formed on the rear end of the peripheral wall 530 of the insulation sleeve 53. The engagement protrusion 50b is engaged with the engagement recess 53b to lock the insulation sleeve 53 to the insulator 50.

As shown in FIGS. 13-17, in the illustrated embodiment, the front end wall 531 of the insulation sleeve 53 is pressed against the front end surface of the main body 500 of the insulator 50, and a through-hole is formed in the front end wall 531 of the insulation sleeve 53 to allow the data terminal 52 to pass through. The front end of the data terminal 52 extends out of the through-hole of the front end wall 531 of the insulation sleeve 53 for mating with a mating data terminal.

As shown in FIG. 17, in the illustrated embodiment, a guide rib 50c extending along the axial direction of the main body 500 of the insulator 50 is formed on the main body 500 of the insulator 50, and the guide rib 50c separates adjacent two receiving slots 501. A guide slot 53c extending along the axial direction is formed on the inner side of the peripheral wall 530 of the insulation sleeve 53, and the guide rib 50c cooperates with the guide slot 53c to guide the insertion of the main body 500 into the insulation sleeve 53.

As shown in FIGS. 13-17, in the illustrated embodiment, the insulator 50 further includes a connecting leg 502 extending backwards from the rear end of the main body 500 and a limiting protrusion 505 formed on the end of the connecting leg 502. The limiting protrusion 505 is located outside the shielding shell 51 and one side of the limiting protrusion 505 is pressed against a limiting step 105a inside the data module hole 105 to axially position the data module 5.

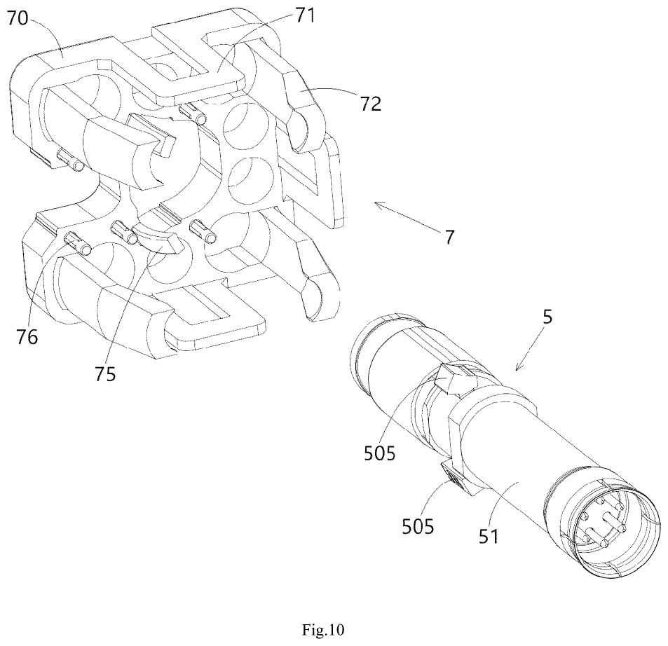

As shown in FIG. 10, in the illustrated embodiment, the connector core assembly further includes an end cover 7, which is installed on the rear end of the core body 1 and formed with multiple through holes corresponding to the power terminal hole 102, signal terminal hole 103, ground terminal hole 104, and data module hole 105, respectively. The end cover 7 includes a cover plate 70 for resting against the rear end surface of the core body 1 and a data module stop arm 75 connected to the cover plate 70. The data module stop arm 75 extends into the data module hole 105 and rests against the other side of the limiting protrusion 505 of the data module 5 to prevent the data module 5 from being pulled out of the data module hole 105.

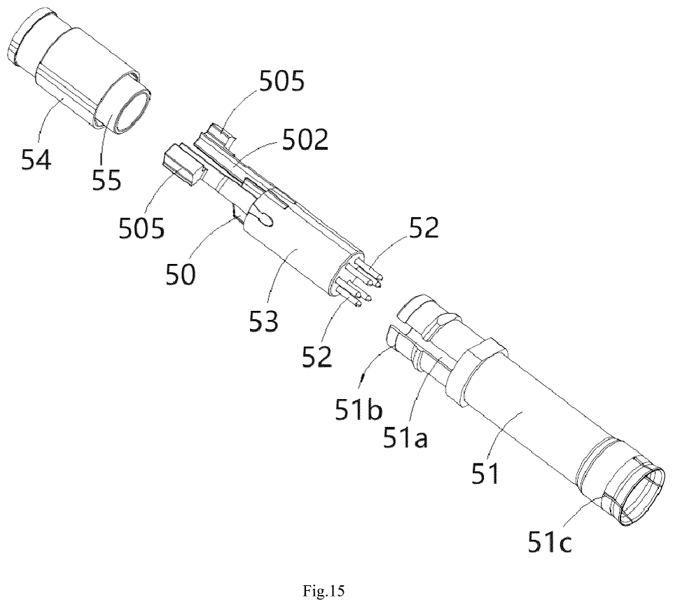

As shown in FIG. 15, in the illustrated embodiment, an axially extending avoidance slot 51a is formed on the peripheral wall of the rear end of the shielding shell 51. The root of the limiting protrusion 505 connected to the connecting leg 502 cooperates with the avoidance slot 51a to guide the insulator 50 to be inserted into the shielding shell 51.

As shown in FIG. 15, in the illustrated embodiment, a plurality of axially extending divide slits 51c are formed in the peripheral wall of the front end of the shielding shell 51, and the multiple divide slits 51c are distributed at intervals in the circumferential direction of the shielding shell 51, so that the peripheral wall of the front end of the shielding shell 51 can be elastically deformed in the radial direction to make electrical contact with an inserted mating shielding shell.

As shown in FIGS. 13-17, in the illustrated embodiment, the data module 5 further includes a support sleeve 55 and a crimping ring 56. The crimping ring 56 is fitted onto the rear end of the support sleeve 55. The crimping ring 56 is used to connect the shielding layer of the data cable to the rear end of the support sleeve 55, and the front end of the support sleeve 55 is inserted into the rear end of the shielding shell 51.

As shown in FIGS. 13-17, in the illustrated embodiment, the data module 5 further includes a locking sleeve 54, which is fitted onto the support sleeve 55 and the crimping ring 56. On the inner peripheral surface of the locking sleeve 54, a first step 54a is formed, and on the outer peripheral surface of the supporting sleeve 55, a second step 55a is formed. The first step 54a and the second step 55a respectively abut against the axial ends of the crimping ring 56 to axially position the crimping ring 56.

As shown in FIGS. 13-17, in the illustrated embodiment, a first protrusion 51b is formed on the outer peripheral surface of the rear end of the shielding shell 51, and a second protrusion 54b is formed on the inner peripheral surface of the front end of the locking sleeve 54. The rear end of the shielding shell 51 is inserted into the front end of the locking sleeve 54, and the first protrusion 54b is engaged with the second protrusion 54b to connect the shielding shell 51 to the locking sleeve 54.

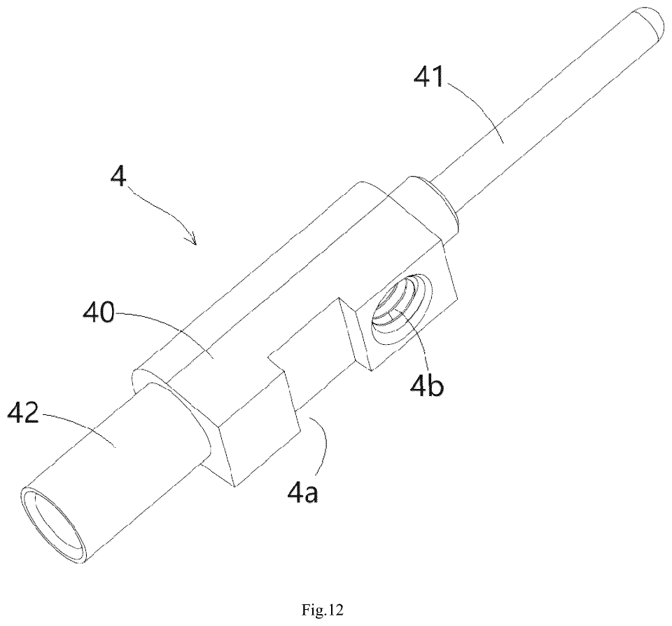

As shown in FIG. 12, in the illustrated embodiment, the grounding terminal 4 includes a mating part 41, a connecting part 42, and a block part 40. The mating part 41 is located at one end of the grounding terminal 4 and is used to mate with a mating grounding terminal. The connecting part 42 is located at the other end of the grounding terminal 4 and is used for electrical connection to a grounding wire. The connecting part 42 can be crimped to the grounding wire, for example. The block part 40 is located between the mating part 41 and the connecting part 42, and is used to be fixed in the grounding terminal hole 104. In the illustrated embodiment, the cross-section of the block part 40 is horseshoe shaped, and the grounding terminal hole 104 is mated with the block part 40 to position it.

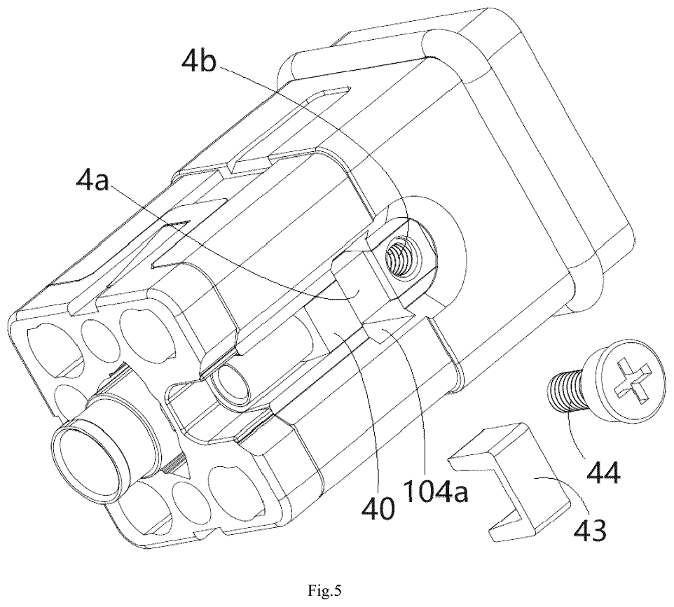

As shown in FIGS. 5 and 12, in the illustrated embodiment, a first snap slot 4a is formed on the block part 40, and a second snap slot 104a is formed on the inner wall surface of the grounding terminal hole 104. The first snap slot 4a and the second snap slot 104a form a C-shaped snap slot. The connector core assembly also includes a C-shaped holder 43, which is inserted into the C-shaped snap slot composed of the first snap slot 4a and the second snap slot 104a to axially position the grounding terminal 4.

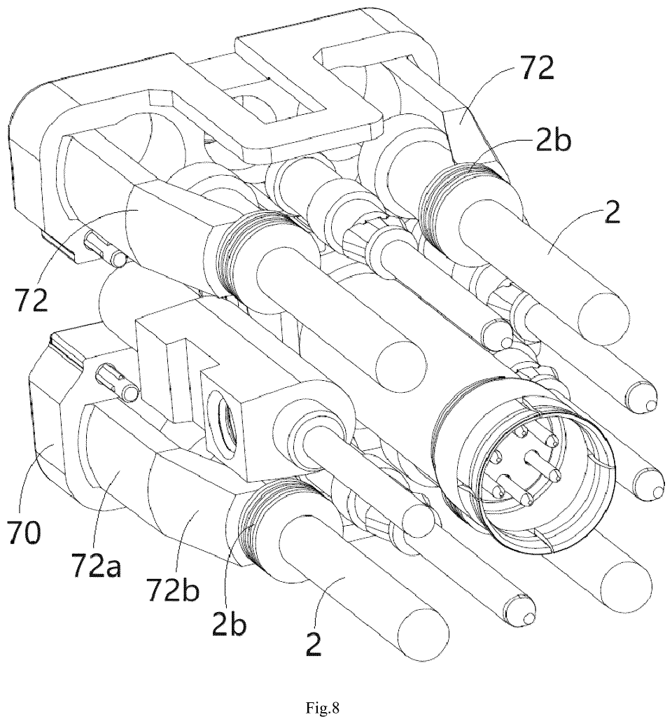

As shown in FIG. 8, in the illustrated embodiment, a radial flange 2b is formed on the power terminal 2, and one side of the radial flange 2b is pressed against a step inside the power terminal hole 102 to axially position the power terminal 2. The end cover 7 also includes a power terminal stop arm 72 connected to the cover plate 70. The power terminal stop arm 72 extends into the power terminal hole 102 and rests against the other side of the radial flange 2b to prevent the power terminal 2 from being pulled out of the power terminal hole 102.

As shown in FIG. 8, in the illustrated embodiment, the power terminal stop arm 72 includes a straight arm portion 72a and an inclined arm portion 72b. One end of the straight arm portion 72a is connected to the cover plate 70 and extends along the axial direction of the core body 1 from the cover plate 70. The inclined arm portion 72b is connected to the other end of the straight arm portion 72a and extends obliquely with respect to the axial direction. The end of the inclined arm portion 72b is pressed against the radial flange 2b of the power terminal 2.

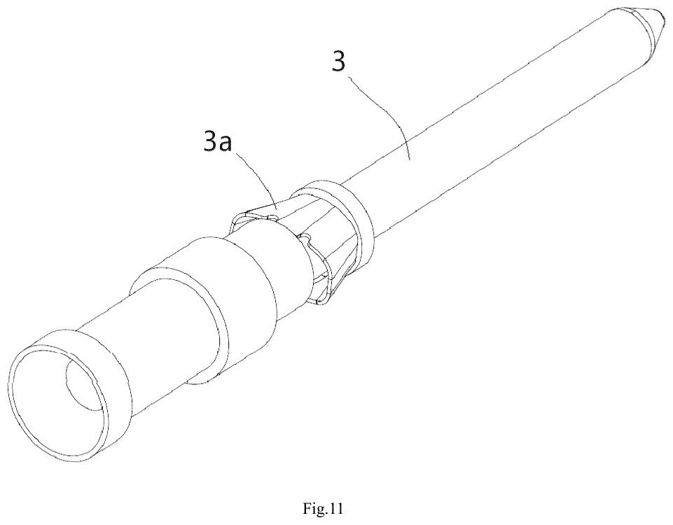

FIG. 11 shows an illustrative perspective view of a signal terminal 3 of a connector core assembly according to an exemplary embodiment of the present invention. In the illustrated embodiment, an elastic locking component 3a is installed on the signal terminal 3, and the elastic locking component 3a is pressed against a step inside the signal terminal hole 103 to prevent the signal terminal 3 from being pulled out of the signal terminal hole 103.

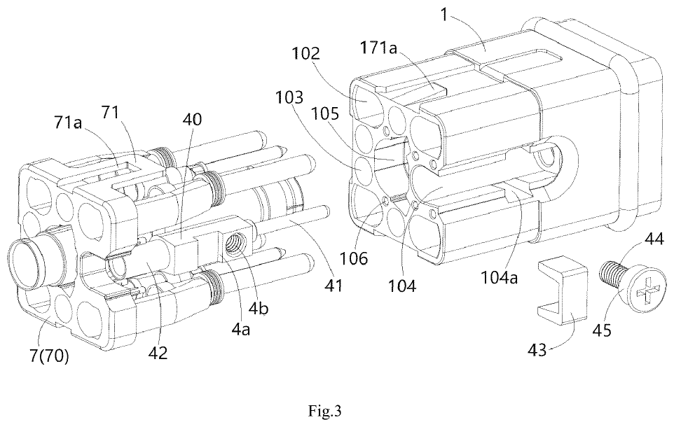

As shown in FIG. 10, in the illustrated embodiment, the end cover 7 further includes a buckle 71 connected to the side edge of the cover plate 70, and a slot hole 71 is formed in the buckle 71. A protrusion 171a is formed on the outer side of the rear end of the core body 1, as shown in FIG. 3, and the protrusion 171a is engaged with the slot hole 71 of the buckle 71 to fix the end cover 7 to the rear end of the core body 1.

As shown in FIGS. 3 and 10, in the illustrated embodiment, the end cover 7 further includes multiple engagement posts 76 protruding from the inner side of the cover plate 70, and multiple engagement holes 106 are formed in the rear end surface of the core body 1. The multiple engagement posts 76 are respectively inserted into the multiple engagement holes 106 in an interference fit manner to increase the engagement force between the end cover 7 and the core body 1.

In the illustrated embodiment, the connector core assembly includes four power terminals 2, four signal terminals 3, one ground terminal 4, and one data module 5. Four power terminals 2, four signal terminals 3, and one ground terminal 4 are arranged around the data module 5, and the data module 5 includes six data terminals 52. In the illustrated embodiment, the cross-sectional area of power terminal 2 can reach up to 4 square millimeters, the cross-sectional area of signal terminal 3 can reach up to 2.5 square millimeters, and the cross-sectional area of ground terminal 4 can reach up to 4 square millimeters.

In another exemplary embodiment of the present invention, a connector is also disclosed. The connector includes a connector housing and the aforementioned connector core assembly. The connector core assembly is inserted into the connector housing.

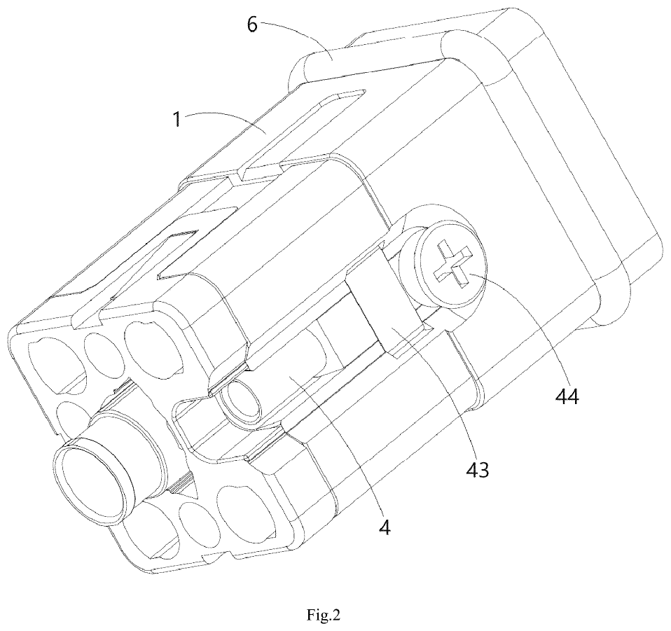

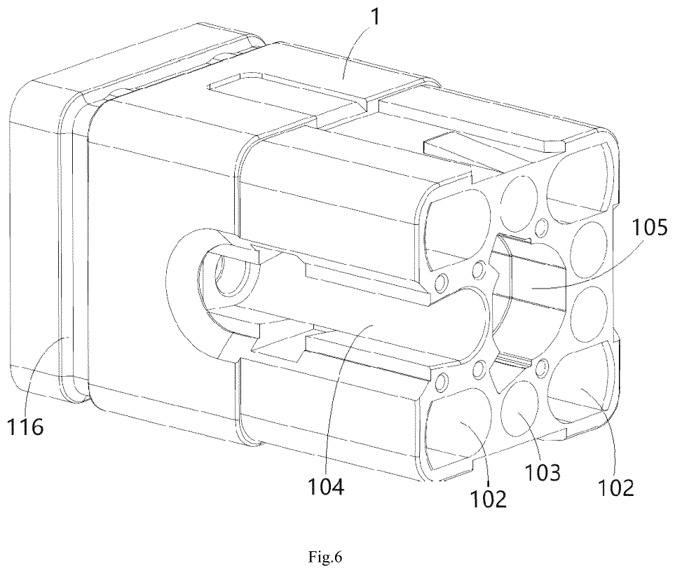

As shown in FIG. 6, in the illustrated embodiment, a sealing ring installation groove 116 is formed on the outer surface of the core body 1, and the connector further includes a first scaling ring 6, shown in FIG. 2, installed in the sealing ring installation groove 116. The first scaling ring 6 is radially compressed between the connector housing and the core body 1 to achieve sealing between the two.

As shown in FIG. 3, in the illustrated embodiment, a threaded hole 4b is formed in the ground terminal 4, and a connection hole is formed in the connector housing. The connector also includes a threaded connection piece 44, which passes through the connection hole and is threaded into the threaded hole 4b to fix the connector core assembly in the connector housing.

As shown in FIG. 3, in the illustrated embodiment, the connector further includes a second sealing ring 45. The second sealing ring 45 is fitted onto the threaded connection piece 44. The second sealing ring 45 is compressed between the head of the threaded connection piece 44 and the connector housing, and surrounds the opening of the connection hole for sealing the connection hole.

In another exemplary embodiment of the present invention, a connector assembly is also disclosed. The connector assembly includes: the aforementioned connector and a mating connector which is mated with the connector.

In an exemplary embodiment of the present invention, the connector is a male connector and the mating connector is a female connector. However, the present invention is not limited to the illustrated embodiments. For example, the aforementioned connector may be a female connector, and the aforementioned mating connector may be a male connector.

In the aforementioned exemplary embodiments of the present invention, the connector core assembly integrates 4 power terminals (with the cross-sectional area up to 4.0 square millimeters), 4 signal terminals (with the cross-sectional area up to 2.5 square millimeters), 6 Cat5 data transmission terminals, and 1 ground terminal (with the cross-sectional area up to 4.0 square millimeters), replacing the functionality that can only be achieved by the client using multiple connectors, greatly reducing costs.

The connector core assembly of the present invention is used for the smallest housing of heavy-duty connectors and has a natural advantage of miniaturization. The multiple terminals in the connector core assembly of the present invention are independently installed, and the client can freely combine them, providing multiple solutions and features such as versatility and high convenience. The data module of the present invention adopts a 360° shielding design, which can connect 6 data terminals and achieve data transmission of Cat 5. The crimping connection can be used between the grounding terminal and the grounding wire, which has more reliable electrical and mechanical stability and saves space.

In the aforementioned exemplary embodiments according to the present invention, the connector not only integrates power terminals, signal terminals, and ground terminals, but also integrates a data module for transmitting data. Therefore, the connector of the present invention can simultaneously achieve the transmission of power, signals, and data, and has good grounding and electromagnetic shielding functions. Therefore, the present invention does not require a separate data connector, reducing costs, decreasing volume, and improving usability.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector core assembly, comprising:
a core body having a power terminal hole, a signal terminal hole, a grounding terminal hole, and a data module hole;
a power terminal disposed in the power terminal hole;
a signal terminal disposed in the signal terminal hole;
a grounding terminal disposed in the grounding terminal hole; and
a data module disposed in the data module hole, the data module includes a shielding shell, an insulator installed in the shielding shell, and a plurality of data terminals disposed in the insulator, the shielding shell isolates the data terminals from the power terminal, the signal terminal, and the ground terminal.

2. The connector core assembly according to claim 1, wherein the data terminals are used for transmitting Ethernet data.

3. The connector core assembly according to claim 1, wherein the insulator has a main body that is cylindrical, a plurality of receiving slots that are outward opening are formed on an outer peripheral surface of the main body, the receiving slots extend along an axial direction of the main body and are distributed at intervals in a circumferential direction of the main body, the data terminals are respectively provided in the receiving slots.

4. The connector core assembly according to claim 3, wherein a C-shaped snap ring portion is formed in one of the receiving slots, and a snap slot is formed on one of the data terminals, the C-shaped snap ring portion is snapped into the snap slot to hold the one of the data terminals in the one of the receiving slots.

5. The connector core assembly according to claim 3, wherein the data module includes an insulation sleeve fitted onto the main body of the insulator, a peripheral wall of the insulation sleeve rests against the one of the data terminals to constrain the one of the data terminals in the one of the receiving slots of the insulator, an engagement protrusion is formed on an outer surface of a rear end of the main body of the insulator, and an engagement recess is formed on a rear end of the peripheral wall of the insulation sleeve, the engagement protrusion is engaged with the engagement recess to lock the insulation sleeve onto the insulator.

6. The connector core assembly according to claim 5, wherein a front end wall of the insulation sleeve is pressed against a front end surface of the main body of the insulator, and a through-hole is formed in the front end wall of the insulation sleeve to allow the one of the data terminals to pass through, the front end of the one of the data terminals extends out of the through-hole in the front end wall of the insulation sleeve for mating with a mating data terminal.

7. The connector core assembly according to claim 6, wherein a guide rib extending along the axial direction is formed on the main body of the insulator, the guide rib separates adjacent receiving slots, a guide slot extending along the axial direction is formed on an inner side of the peripheral wall of the insulation sleeve, the guide rib cooperates with the guide slot to guide the main body to be inserted into the insulation sleeve.

8. The connector core assembly according to claim 3, wherein the insulator includes a connecting leg extending backwards from a rear end of the main body and a limiting protrusion formed on an end of the connecting leg, the limiting protrusion is located outside the shielding shell and a side of the limiting protrusion is pressed against a limiting step inside the data module hole to axially position the data module.

9. The connector core assembly according to claim 8, further comprising an end cover installed on a rear end of the core body and having a plurality of through holes corresponding to the power terminal hole, the signal terminal hole, the grounding terminal hole, and the data module hole, respectively, the end cover has a cover plate resting against a rear end face of the core body and a data module stop arm connected to the cover plate, the data module stop arm extends into the data module hole and rests against another side of the limiting protrusion of the data module to prevent the data module from being pulled out of the data module hole.

10. The connector core assembly according to claim 8, wherein an avoidance slot extending along the axial direction is formed on a peripheral wall of a rear end of the shielding shell, a root of the limiting protrusion connected to the connecting leg cooperates with the avoidance slot to guide the insulator to be inserted into the shielding shell.

11. The connector core assembly according to claim 1, wherein the data module includes a support sleeve and a crimping ring on a rear end of the support sleeve, the crimping ring connects a shielding layer of a data cable to the rear end of the support sleeve, a front end of the support sleeve is inserted into a rear end of the shielding shell.

12. The connector core assembly according to claim 11, wherein the data module includes a locking sleeve fitted onto the support sleeve and the crimping ring, a first step is formed on an inner peripheral surface of the locking sleeve, and a second step is formed on an outer peripheral surface of the support sleeve, the first step and the second step respectively abut against a pair of axial ends of the crimping ring to axially position the crimping ring.

13. The connector core assembly according to claim 1, wherein the grounding terminal includes:
a mating part located at an end of the grounding terminal, the mating part mating with a mating grounding terminal;
a connecting part located at another end of the grounding terminal, the connecting part electrically connecting to a grounding wire; and
a block part located between the mating part and the connecting part and fixed in the grounding terminal hole, a cross-section of the block part is horseshoe shaped, the grounding terminal hole cooperates with the block part to position the block part.

14. The connector core assembly according to claim 13, wherein a first snap slot is formed on the block part, and a second snap slot is formed on an inner wall surface of the grounding terminal hole, the first snap slot and the second snap slot form a C-shaped snap slot, the connector core assembly includes a C-shaped holder inserted into the C-shaped snap slot to axially position the grounding terminal.

15. The connector core assembly according to claim 9, wherein a radial flange is formed on the power terminal, a side of the radial flange is pressed against a step inside the power terminal hole to axially position the power terminal, the end cover has a power terminal stop arm connected to the cover plate, the power terminal stop arm extends into the power terminal hole and rests against another side of the radial flange to prevent the power terminal from being pulled out of the power terminal hole.

16. The connector core assembly according to claim 15, wherein the power terminal stop arm includes:
a straight arm portion, an end of the straight arm portion is connected to the cover plate and extends along the axial direction of the core body from the cover plate; and
an inclined arm portion connected to another end of the straight arm portion and extending obliquely with respect to the axial direction, an end of the inclined arm portion is pressed against the radial flange of the power terminal.

17. The connector core assembly according to claim 9, wherein the end cover has a buckle connected to a side edge of the cover plate, and a slot hole is formed in the buckle, a protrusion is formed on an outer side of the rear end of the core body, the protrusion is engaged into the slot hole of the buckle to fix the end cover to the rear end of the core body, the end cover has a plurality of engagement posts protruding from an inner side of the cover plate, and a plurality of engagement holes are formed in a rear end surface of the core body, the engagement posts are respectively inserted into the engagement holes in an interference fit manner to increase an engagement force between the end cover and the core body.

18. A connector, comprising:
a connector housing; and
a connector core assembly inserted into the connector housing, the connector core assembly includes:
a core body having a power terminal hole, a signal terminal hole, a grounding terminal hole, and a data module hole;
a power terminal disposed in the power terminal hole;
a signal terminal disposed in the signal terminal hole;
a grounding terminal disposed in the grounding terminal hole; and
a data module disposed in the data module hole, the data module includes a shielding shell, an insulator installed in the shielding shell, and a plurality of data terminals disposed in the insulator, the shielding shell isolates the data terminals from the power terminal, the signal terminal, and the ground terminal.

19. The connector according to claim 18, wherein a threaded hole is formed in the grounding terminal, and a connection hole is formed in the connector housing, the connector includes a threaded connection piece that passes through the connection hole and is threaded into the threaded hole to fix the connector core assembly in the connector housing.

20. A connector assembly, comprising:
a connector including a connector housing and a connector core assembly inserted into the connector housing, the connector core assembly includes:
a core body having a power terminal hole, a signal terminal hole, a grounding terminal hole, and a data module hole;
a power terminal disposed in the power terminal hole;
a signal terminal disposed in the signal terminal hole;
a grounding terminal disposed in the grounding terminal hole; and
a data module disposed in the data module hole, the data module includes a shielding shell, an insulator installed in the shielding shell, and a plurality of data terminals disposed in the insulator, the shielding shell isolates the data terminals from the power terminal, the signal terminal, and the ground terminal; and
a mating connector mated with the connector.
